(19) United States
(12) Patent Application Publication
(10) Pub. No.: US 2009/0299839 A1
(43) Pub. Date: Dec. 3, 2009

(54) First in Home Marketing Method

(76) Inventors: Jason Uhl, Carlsbad, CA (US); Dan Whitfield, Highlands Ranch, CO (US)

Correspondence Address: Trevor Coddington;Paul, Hastings, Janofsky & Walker LLP, P.O> Box 919092, San Diego, CA, 92191--909, US

(21) Appl. No.: 12/127,168

(22) Filed: May 27, 2008

(51) Int. Cl. G06Q 30/00

(52) U.S. Cl. 705/14.11; 705/14.15

(57) ABSTRACT

Time is of the essence when advertising to new homeowners. The present invention is an advertising technique that enables advertisers to reach new homeowners at the time of closing of the new homeowner's home purchase. Hence, advertisers advertising via the present invention are able to reach potential customers at least several days, even weeks, if not months, before other advertisers using conventional approaches.

### BACKGROUND OF THE INVENTION

1. Field of Invention

This invention relates to marketing and more specifically to a targeted advertising approach to the new homeowner market segment.

2. Description of Related Art

The American dream to most people means owning a home. Buying a new home is a positive event and new homeowners are in a spending mood. The economy generally does not affect new homeowners or they would not have been able to purchase a home in the first place. New homeowners are credit rich and spend more in the first 90 days after moving in than regular consumers.

Marketing to new homeowners (a collection of individuals referred to collectively as “the new homeowner market segment”) is extremely desirable. New homeowners have money as they have above average income and many have equity from previous purchases and have liquid assets. New homeowners have great credit as they just went through comprehensive credit processes to qualify for home loans. Moreover, new homeowners generally do not have established buying habits. Unless the move for the new homeowner was within the same neighborhood, their previous businesses and professionals did not move with them. New homeowners are anxious to find new businesses and professionals in their new community. They are generally elated with their new purchase and will be on a spending spree for many months, even years. In fact, it has been reported that 78% of new homeowners plan on spending $10,000 to $25,000 on products/services related to their home in the first year on average. An additional 14% of new homeowners plan on spending up to $40,000 and another 6% plan on spending over $40,000. New homeowners will often spend 8 to 10 times more than an established resident will over the next few years.

Traditional advertising techniques such as direct mail, cold-calling, yellow pages, online directories, welcome wagon programs, home magazines, and newspaper advertising are very inefficient. For example, only approximately one percent of homeowners respond to direct mail advertisements. Even though a new homeowner's mailbox is not yet cluttered, direct mail advertisements are often discarded in the trash as useless and impersonal.

Conventional services are available that provide advertisers with homeowner leads. These leads are often distributed via mailing lists provided on a weekly or monthly basis. However, time is of the essence when contacting new homeowners. Assembling a mailing list requires time and is often dependent on another entity such as a title company registering the deed of sale. This registration information typically comes from public records, located at the local land registry office, and is not made publicly available until a significant amount of time has lapsed after closing of the real estate transaction. By then, the new homeowner has already moved in and/or begun spending on new goods and services.

### SUMMARY OF THE INVENTION

The present invention overcomes these and other deficiencies of the prior art by providing a technique for reaching new homeowners at the closing of the home purchase or shortly thereafter.

In an embodiment of the invention, a method of advertising to new homeowners comprises the steps of: receiving an advertising package, wherein the advertising package comprises one or more advertisements associated with one or more vendors, and transferring the advertising package to a buyer of real estate or an agent of the buyer, wherein the step of transferring occurs before or on a day of closing a real estate transaction involving the real estate. The one or more advertisements can comprise a gift card, which is associated with an amount of money honored by a particular vendor. The advertising package may comprise a gift basket. Preferably, the one or more vendors are geographically located in a locality of the real estate. The steps of receiving and transferring can be performed by a title or escrow company.

In another embodiment of the invention, a method of advertising to new homeowners comprises the steps of: assembling an advertising package, wherein the advertising package comprises one or more advertisements associated with one or more vendors, and transferring the advertising package to an entity facilitating a closing of a real estate transaction, wherein the entity provides the advertising package to a buyer or an agent of the buyer before or on a day that the closing of a real estate transaction is set to occur. The step of assembling further may comprise the step of forming one or more contracts with the one or more vendors to advertise in the advertisement package.

In yet another embodiment of the invention, a method of advertising to new homeowners comprises the steps of: generating a lead prior to closing of a real estate transaction involving real property, wherein the lead comprises information associated with a buyer of the real property and/or the real property, and communicating the lead to a party, prior to the closing, whom is not involved in the closing. The step of generating a lead may be performed by a facilitator of the closing or alternatively a party privy to the information. The information may comprise data selected from the group consisting of: identity of the buyer, current address of the buyer, address of the real property, and a combination thereof. The party can be selected from the group consisting of: information broker, advertiser, and provider of an advertising package. The method may further comprise the steps of: assembling an advertising package, wherein the advertising package comprises one or more advertisements associated with one or more vendors, and transferring the advertising package to an entity facilitating the closing, wherein the entity provides the advertising package to a buyer or an agent of the buyer before or on a day that the closing is set to occur.

The present invention provides numerous advantages over conventional approaches. One advantage of the invention is that it provides a reliable distribution channel. Every new homeowner legally must use a title closing company. Partnering with title companies thereby insures every homeowner can receive an advertising package. Moreover, before a new homeowner can take possession title documents must be executed. The advertising package according to the present invention is received before or at the time of the execution of those documents. This insures that advertising is received in advance of other companies' offers that can only be received after the point of possession.

New homeowners trust their realtor and/or title company. That's why they have chosen those vendors. A gift basket according to the present invention that is perceived as coming from a trusted vendor positions their recommendation in the most favorable light.

Because a gift basket according to the present invention may include gifts like chocolates, a bottle of wine, crackers, cheeses, gift certificates, and the like it is received by the new homeowner positively. Many subsequent advertising offers through convention techniques are received with some measure of mistrust and thus often are discarded. A gift basket is appreciated and valued. This once again puts it's accompanied advertising offers in a most favored position. In addition, because all of gift card offers may come in a notebook they are readily available in one convenient location and are easily accessible.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates an advertising method according to an embodiment of the invention.

### DETAILED DESCRIPTION OF EMBODIMENTS

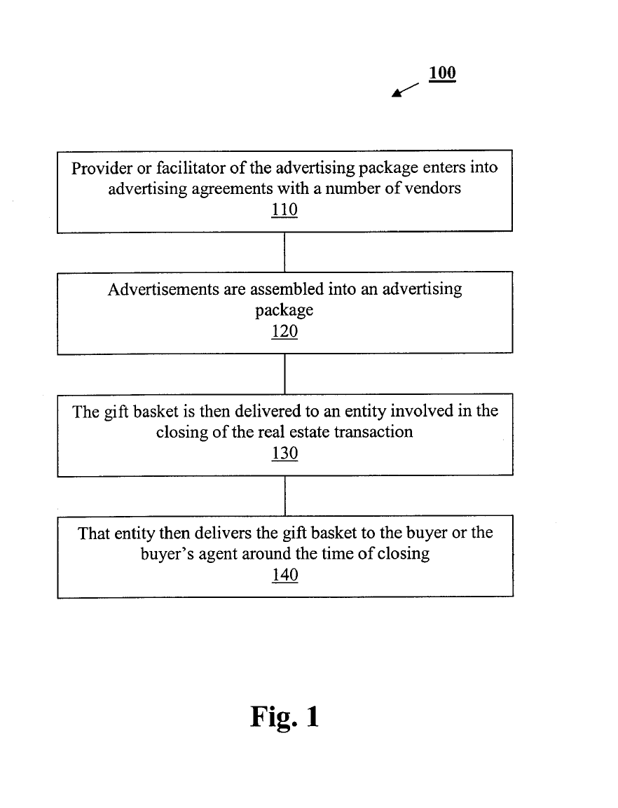

Further features and advantages of the invention, as well as the structure and operation of various embodiments of the invention, are described in detail below with reference to the accompanying FIG. 1. The embodiments of the invention are described in the context of a marketing and/or advertising technique for reaching new homeowners at or near the time of closing of the home purchase. Nonetheless, one of ordinary skill in the art readily recognizes that the present technique may be applied to other transactions where providing advertisements at or around the time of closing is preferable.

The present invention provides a technique for targeted advertising that is able to reach new homeowners before, at, or immediately after the time the new homeowner closes the purchase of the home. Conventional advertising techniques of reaching new homeowners are dependent on information services that scour public records of previously consummated real estate transactions to identify new homeowners. Yet, the time period between actual closing of a real estate transaction and the recording of such becoming publicly available via, for example, a county real estate recording agency, can be significant, i.e., weeks if not months after closing of the real estate transaction. Thus, conventional advertising techniques waste precious time. It is well settled that new homeowners are in a spending mode and the sooner one can advertise to a new homeowner, upon closing of the home purchase, the more receptive the new homeowner will be to such advertising.

In general, after a buyer's formal offer to purchase real estate, i.e., real property, is accepted by a seller, the buyer and seller enter into a purchase contract and set a closing date, which is usually several weeks after the formal offer is accepted. On the closing date, the parties consummate the purchase contract and ownership of the property is transferred to the buyer. Typically, the buyer attends the closing in person or has an agent, e.g., real estate agent or broker, appear and act on her behalf.

Several things happen during closing. The buyer (or her bank) tenders payment (generally a Cashier's check or wire transfer) for the balance owed on the purchase price. The seller signs the deed over to the buyer, and gives her the keys. A title company, lawyer, or civil law notary registers the new deed with the local land registry office. The seller receives payment for the proceeds of the sale, less closing costs, and mortgage payouts.

Closing in escrow usually occurs in western states. A title company (rather than a lawyer) or other trusted party holds the money and the signed deed, and arranges for the transfer. This is primarily so that the seller can give up ownership of the property, and the buyer can hand over the payment, without both parties having to be present at the same time. Escrow ensures an orderly transaction.

In other states, settlement (as closing is called) takes place on a specified date and time during which all parties (usually including the agents involved) meet at a settlement company presided over or supervised by a lawyer. The transfer of money (in form of certified or wired funds) and the property takes place, and the deed is then recorded by the company. The terms “closing” or “closing date” as further used herein are intended to encompass this type of settlement, i.e., “settlement” and “settlement date,” respectively.

The present invention leverages knowledge of the buyer's identity prior to or at the closing date. This information will be possessed by a title company, lawyer, civil notary, settlement company, real estate agent, real estate broker, loan officer, or other trusted party involved in or presiding over the closing of the real estate transaction. In an embodiment of the invention, these entities are the means by which an advertisement package can be delivered to the buyer, i.e., the new homeowner, before, during or soon after closing. For example, the provider of the advertising package forms a relationship with an entity involved in or presiding over the closing. The advertising package is provided to the entity involved in or presiding over the closing, whom then transfers it to the buyer either directly or through an intermediary such as the buyer's agent at or near the time of closing. Alternatively, the address of the property involved in the purchase is obtained by the entity involved in or presiding over the closing or some other entity privy to such, and is communicated to the provider of the advertising package prior to or at closing. The provider of the advertising package then delivers the advertising package to the address before, at, or soon after closing, thereby reaching the buyer prior to moving in. In yet another alternative embodiment, the provider of the advertising package can deliver the advertising package to some other address associated with the buyer before, at, or soon after the time of closing.

In an embodiment of the invention, the advertising package comprises a number of advertisements from vendors of goods and services. Preferably, the vendors supply goods and/or services within the vicinity of the property that was purchased since the new homeowner will be new to the area and is open to purchasing goods and/or services from nearby vendors. Examples vendors could be shops, restaurants, cleaners, medical doctors, lawyers, grocery stores, and gas stations. This list is not meant to be all-inclusive as many other types of providers of goods and/or services can be advertisers/vendors, the identification of which is readily apparent to one of ordinary skill in the art. The vicinity could be limited to a few miles, a zip code, or a town or city. In sum, advertisers want to bring new customers into their stores and new homeowners, many of whom have no ties to the new area around their purchased property and hence no ties to any particular vendor, are ideal targets. Local vendors who sell staples or services that every consumer needs, or goods that a new homeowner needs, such as home improvement goods and home furnishings, are ideal advertising candidates.

In another embodiment of the invention, the advertisements comprise one or more gift cards that can be tendered in nearby stores. For example, a vendor such as Lowe's Home Improvement can include a $20 gift card in the advertising package, which is redeemable at a nearby Lowe's store. Gift cards are preferable as they encourage new customers to enter the store and use the gift card. Typically, gift card users spend beyond the amount associated with the gift card. Moreover, many gift card users end up being repeat customers. Advertisers realize that if they can get a new customer in the store, which gift cards work well at doing such, that customer now knows of the location of the store and will likely return to buy additional goods and/or services, or even encourage others such as family members to buy additional goods and/or services from that vendor. This is a tremendous advantage for vendors who advertise via the present invention as opposed to those who don't.

Multiple vendors can advertise, e.g., provide gift cards, in the advertisement package. For example, multiple vendors across multiple industries or markets can each provide gift cards to be included in the advertising package. These gift cards can be provided in a gift card album or book. In an embodiment of the invention, certain vendors may enter into an exclusive advertising arrangement with the provider of the advertising package. For example, Lowe's may enter into an exclusive advertising agreement where its competitors are not able to advertise via the advertising package.

In an embodiment of the invention, vendors advertising in the advertisement package pay for the right to advertise in that package. A premium amount may be charged for an exclusive arrangement as discussed above.

Of course, other types of advertising means may be used instead of gift cards. For example, a vendor may advertise in the advertising package via a coupon, flyers, magnetic tip-ons, and buyers guide. In an alternative embodiment, a vendor may advertise its good and/or services by sponsoring a gift to be included in the advertising package. For example, the gift may comprise a bottle of wine, cheese, fruit, chocolate, tape measures, pens, refrigerator magnets, or anything that a new homeowner would find useful and/or thoughtful.

In an embodiment of the invention, the advertising package comprises a gift basket. The gift basket may include one or more gift cards, various sponsored items, and other advertisements. A gift basket is preferable as it stands out and makes a lasting impression on the new homeowner. However, other forms of advertising packages may be provided, the identification and implementation of which is apparent to one of ordinary skill in the art.

FIG. 1 illustrates a method 100 according to an embodiment of the invention. The method 100 comprises a number of steps, first starting with the assembly of the advertising package. For example, the provider or facilitator of the advertising package enters (step 110) into advertising agreements with a number of vendors, whom supply advertisements such as, but not limited to gift cards, and/or select sponsored items. Those advertisements are assembled (step 120) into a gift basket—the gift basket being part of the advertising package or the advertising package itself. The gift basket is then delivered (step 130) to an entity involved in the closing of the real estate transaction. That entity then delivers (step 140) the gift basket to the buyer or the buyer's agent around the time of closing. Preferably, the buyer or buyer's agent receives the gift basket at the closing event. The gift basked can even be guised as a gift from the facilitator of the closing, e.g., the lawyer, title company, or settlement company handling the closing.

As discussed above, other delivery mechanisms and timing schemes can be implemented. For example, the gift basket can be delivered to the property involved in the sale immediately after closing. The gift basket can be placed in the new home by the buyer's real estate agent. The gift basket can be provided immediately before or after closing.

In another embodiment of the invention, new homeowner leads are generated prior to closing based on the information available to the facilitator of the closing or anyone privy to the buyer's information. These leads can be bought and sold to interested advertisers or an intermediary information broker such as a lead provider. Alternatively, these leads can be transmitted to the provider of the advertising package as discussed above, who then delivers the advertising package to the buyer or buyer's agent before, during, or shortly after the time of closing.

In sum, time is of the essence when advertising to new homeowners. The present invention is an advertising technique that enables advertisers to reach new homeowners at the time of closing of the new homeowner's home purchase. Hence, advertisers advertising via the present invention are able to reach potential customers at least several days, even weeks, if not months, before other advertisers using conventional approaches.

New homeowners include, but are not limited to first time homeowners, repeat homeowners, investors in real estate, purchasers of foreclosed property, and commercial property owners.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed.

We claim:

1. A method of advertising to new homeowners, the method comprising the steps of:
receiving an advertising package, wherein said advertising package comprises one or more advertisements associated with one or more vendors, and
transferring said advertising package to a buyer of real estate or an agent of said buyer, wherein the step of transferring occurs before or on a day of closing a real estate transaction involving said real estate.

2. The method of claim 1, wherein said one or more advertisements comprise a gift card.

3. The method of claim 2, wherein said gift card includes an amount of money honored by a particular vendor.

4. The method of claim 1, wherein said advertising package comprises a gift basket.

5. The method of claim 1, wherein said one or more vendors are geographically located in a locality of said real estate.

6. The method of claim 1, wherein the steps of receiving and transferring are performed by a title or escrow company.

7. A method of advertising to new homeowners, the method comprising the steps of:
assembling an advertising package, wherein said advertising package comprises one or more advertisements associated with one or more vendors, and
transferring said advertising package to an entity facilitating a closing of a real estate transaction, wherein said entity provides said advertising package to a buyer or an agent of said buyer before or on a day that said closing of a real estate transaction is set to occur.

8. The method of claim 7, wherein said one or more advertisements comprise a gift card.

9. The method of claim 8, wherein said gift card includes an amount of money honored by a particular vendor.

10. The method of claim 7, wherein said advertising package comprises a gift basket.

11. The method of claim 7, wherein said one or more vendors are geographically located in a locality of said real estate.

12. The method of claim 1, wherein the step of assembling further comprises the steps of:
forming one or more contracts with said one or more vendors to advertise in said advertisement package.

13. A method of advertising to new homeowners, the method comprising the steps of:
generating a lead prior to closing of a real estate transaction involving real property, wherein said lead comprises information associated with a buyer of said real property and/or said real property, and
communicating said lead to a party, prior to said closing, whom is not involved in said closing.

14. The method of claim 13, wherein the step of generating a lead is performed by a facilitator of said closing.

15. The method of claim 13, wherein the step of generating a lead is performed by a party privy to said information.

16. The method of claim 13, wherein said information comprises data selected from the group consisting of: identity of said buyer, current address of said buyer, address of said real property, and a combination thereof.

17. The method of claim 13, wherein said party comprises an entity selected from the group consisting of: information broker, advertiser, and provider of an advertising package.

18. The method of claim 13, further comprising the steps of:
assembling an advertising package, wherein said advertising package comprises one or more advertisements associated with one or more vendors, and
transferring said advertising package to an entity facilitating said closing, wherein said entity provides said advertising package to a buyer or an agent of said buyer before or on a day that said closing is set to occur.
